(19) United States
(12) Patent Application Publication
(10) Pub. No.: US 2004/0186905 A1
(43) Pub. Date: Sep. 23, 2004

(54) System and method for provisioning resources

(76) Inventors: Donald E. Young, Merrimack, NH (US); John Sarni, Andover, MA (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/393,423

(22) Filed: Mar. 20, 2003

(51) Int. Cl. G06F 15/173

(52) U.S. Cl. 709/225

(57) ABSTRACT

A system and method that pertains to a provisioning system that may receive information pertaining to a specified service, automatically determine whether resources are available to implement the specified service, acquire the resources, and provision resources to implement the specified service. In accordance with other embodiments, the system and method may monitor the resources against a service level to determine if a malfunction occurs and automatically replace a malfunctioned resource with a new resource. The system and method may align and correlate business processes to services to elements that make up the system and then to related events. The system may allow acquiring additional resources or releasing resources to a pool of available resources as necessary. The structure and method may be used to build a system to perform a desired function and as a tool to evaluate and visualize systems and components that performs those functions.

### BACKGROUND

A data center may permit one or more resources to be used to implement a service. Examples of resources include, without limitation, servers, storage devices, network devices, bandwidth, security features, environmental resources (e.g., power, heat, air conditioning, etc); software (e.g., operating system, middleware, applications), content (e.g., user data, configuration data, etc.) and the like. Examples of services include, without limitation, mail services, Web service, etc. A data center may implement a variety of services for multiple customers. A Service Level Agreement (“SLA”) may be used by which the customer can specify various characteristics and features that the service should provide. An SLA generally comprises a contract between a service provider or enterprise data center operation and a customer that defines, and perhaps guarantees, certain levels of service to the subscriber in return for payment. For example, the SLA may specify an availability parameters (uptime percentage), performance parameters (e.g., throughput), trouble ticket response times, a particular bandwidth or a minimum number of network connections that should be available.

Resources may be deployed to implement a particular service through a process referred to herein as “provisioning.” Conventionally, provisioning may be performed manually, that is, by system or network administrators and the like manually selecting the servers (quantity and type), storage devices, software, etc. to assemble together to provide the customer the desired service(s). The manual provisioning process may require a considerable amount of time and a relatively high level of skill. Further, because of the complexity of the systems and the extent of human involvement in the process, errors may occur. The following subject matter addresses any one or more of these problems.

The area of system management and provisioning are relatively complex and system managers, software developers, and system architects are constantly trying to understand the requirements they are given and build systems by integrating components that will satisfactorily work well together. However, because of the complexity involved tools may be needed to describe and communicate the nature of the solution, as well as to compare alternatives, components and interface points.

### BRIEF SUMMARY

One or more of the problems noted above may be addressed by a system and method pertaining to a provisioning system. The system and method may receive information pertaining to a specified service, automatically determine whether resources are available to implement the specified service and provision resources to implement the specified service. In accordance with other embodiments, the system and method may monitor the resources to determine if a malfunction occurs and automatically replace a malfunctioned resource with a new resource.

### BRIEF DESCRIPTION OF THE DRAWINGS

For a detailed description of the embodiments of the invention, reference will now be made to the accompanying drawings in which:

FIG. 1 shows an exemplary system diagram of a provisioning system in accordance with various embodiments of the invention;

FIG. 2 shows the provisioning system in accordance with various embodiments of the invention;

FIG. 3 shows a block diagram of a control system included in the provisioning system in accordance with various embodiments of the invention;

FIG. 4 shows a block diagram of a computer system on which the provisioning system may be executed in accordance with various embodiments of the invention;

FIG. 5 shows a method for using the architecture structure in accordance with exemplary embodiments of the invention; and

FIG. 6 shows an example of the use of the analysis tool in accordance with embodiments of the invention.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct electrical connection. Thus, if a first device couples to a second device, that connection may be through a direct electrical connection, or through an indirect electrical connection via other devices and connections. Further, all examples included herein should be construed as being open-ended (i.e., not limiting in any way).

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims, unless otherwise specified. In addition, one skilled in the art will understand that the following description has broad application, and the discussion of any embodiment is meant only to be exemplary of that embodiment, and not intended to intimate that the scope of the disclosure, including the claims, is limited to that embodiment.

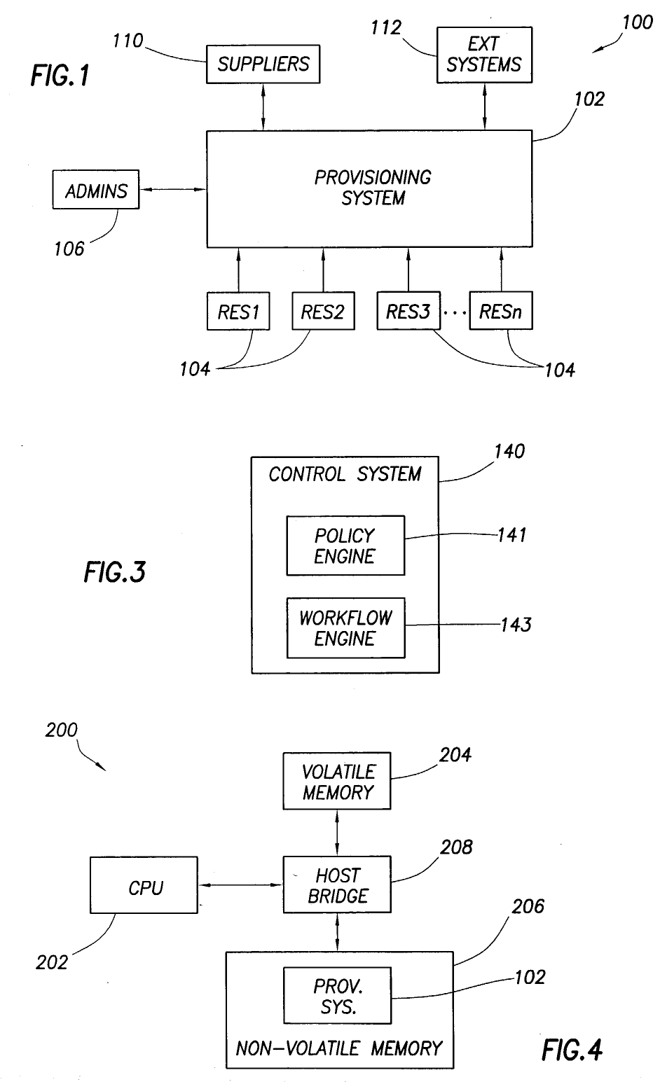

Referring now to FIG. 1, a system 100 is shown as including a provisioning system 102 which may couple to one or more resource elements 104 (RES1, RES2, . . . RESn), one or more administrators 106, one or more suppliers 110 and one or more external systems 112. The provisioning system 102 may be implemented as software that executes on a computer as described below. In accordance with various embodiments of the invention, provisioning system 102 facilitates the creation of one or more “services.” In this context, a service generally comprises an entity that may be used by an end user or software program. Examples of services include, without limitation, Web services, terminal services, streaming media services, mail and messaging services, and e-commerce services. More than one service may coexist at any point in time.

The provisioning system 102 may perform one or more of the following functions: provisioning of resources, control, inventory management, and monitoring. In general, the monitoring function of the provisioning system may monitor various aspects of the system such as hardware operation and the ability of a service to comply with the requirements of an associated service level agreement (“SLA”). The control and inventory functions receive information from the monitoring function and, based on one or more predefined rules, determine or otherwise identify the tasks that the provisioning function may perform. The provisioning functions may execute these tasks to create and modify the various services. The provisioning function aggregates, combines or otherwise selects various of the resources 104 to provide the desired services. These functions may be described in greater detail below.

The resource elements 104 may pertain to any type of data center resource (i.e., asset). The resources may include, without limitation, hardware or software resources. Example of hardware resources may include servers, switches, storage devices, load balancers, etc. Software resources may include operating systems, management agents which collect data, application software, etc. Resources also may include middleware such as message queuing entities, security entities such as firewalls or other intrusion detection entities, and user content such as database content or web site content, as well as resources related to the data center environment such as power distribution, physical location, heat/air conditioning, etc. The information about the resource elements 104 typically resides in the inventory repository(ies) 150.

The administrators 106 may access consoles through which the provisioning system 102 may be controlled. The suppliers 110 may include those entities that provide the resources identified by the resource elements 104. The external systems 112 may include billing systems, asset management, human resource, trouble ticketing and ERP systems, among others.

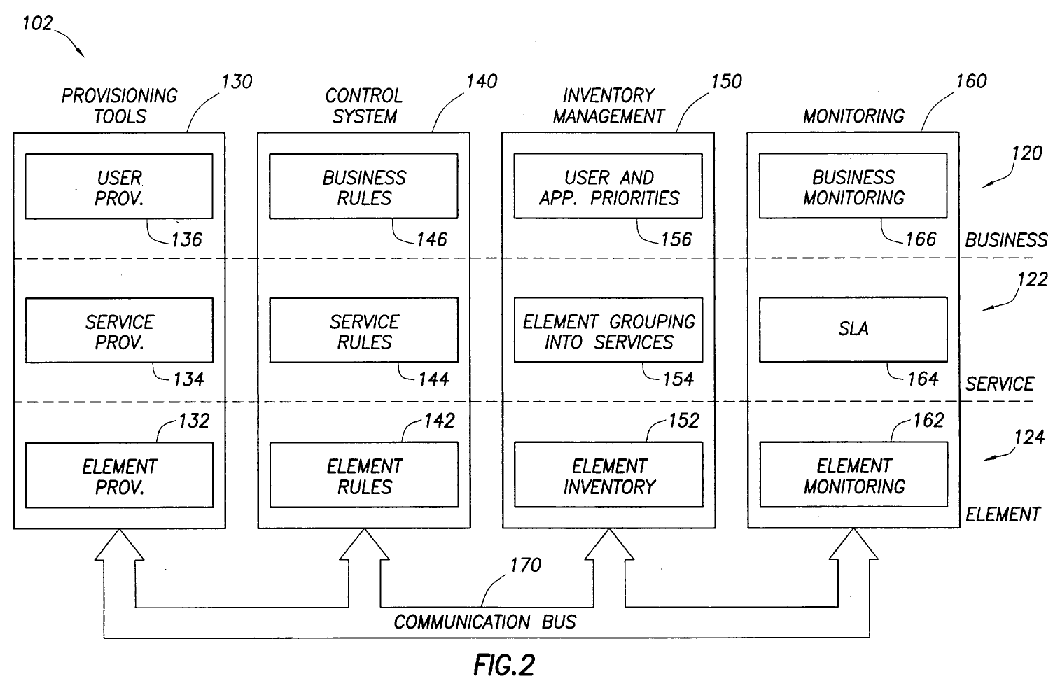

In the exemplary embodiment of FIG. 2, the provisioning system 102 may comprise three layers 120, 122, and 124. Layers 120-124 may comprise a business layer, service layer, and element layer, respectively. The element layer 124 may comprise the lowest level layer and may interact with the various resources 104. Via the element layer 124, resources may be integrated into a service.

The service layer 122 may be built on the element layer 124 and may describe how a service may be created from the resources 104. Service elements may be combined together by the provisioning system 102 in the service layer 122 to create a service. The association of resource elements may be maintained in the service layer 122. As noted above, multiple services may coexist at any point in time. In some cases, resources may be shared between services. For example, a Web service may include a firewall resource, load balancer resources, and five Web server resources which may be shareable with other users.

The business layer 120 generally couples to the service layer and may describe access to, and priorities of, services and the usage of various services available to meet predefined business objectives. At the business layer 120, users may be defined who are allowed to access the services. For each service, an associated policy may be defined that specifies who may be permitted to access the service and circumstances under which the service may be accessed. In some cases, the policy may include all potential users, while in other cases only a subset of users are permitted access to the service. For example, the policy for a Web service may be such that all of an organization's employees are permitted access. For services such as mail services, users may be provisioned which entails setting up accounts that described each user's email rights and privileges. Some users may be granted larger mail stores than other users.

The business layer 120 also may map business objectives of the organization to provisioning tasks. The prioritization of services and users may be performed at the business layer. Prioritization may be useful in the situation in which insufficient resource elements are available to provide all users with the services to which they are authorized. In this situation, the business layer 120 may adjust the services and access to them accordingly. For example, resource elements may be taken from a streaming media service and added to a financial service for the last three days of the month to run financial reports. By way of an additional example, the networking systems could be provisioned to give higher priority users higher priority to an e-commerce service during peak hours than lower priority users.

As noted above, the provisional system 102 may include four functions including, without limitation, provisioning, control, inventory management, and monitoring. These functions may be implemented as depicted in FIG. 2 via provisioning tools 130, control system 140, inventory management 150, and monitoring 160. These functions may be inter-coupled by way of a communication bus 170 which may be implemented in any suitable manner such as by a TIBCO bus or web services.

The provisioning tools function 130 may include components at all three layers 120-124. The resource element provisioning tool 132 may provision a resource element, such as a sever, network device, or storage array. The service provisioning tool 134 may provision all of the resource elements that may be needed to create a service. The service provisioning tool 134 may set the service level and an estimated load. A sufficient number of resource elements could be provisioned to satisfy the specified service level. For example, provisioning a Web service may involve defining the number of servers to satisfy an expected load, identifying the physical servers, identifying the load balancer, configuring the load balancer, provisioning the servers with a desired operating system, setting up firewalls, and loading content.

Once the services have been established, users may be provisioned via the user provisioning tools 136. In some cases, user self-subscription and even self-provisioning may be performed. The end user or administrator may select from a set of available services, those services that the particular user may need. In some cases, different SLAs may used in conjunction with a particular service and the user can select, based, for example, on price, a particular SLA. In response to the user-provisioning request, the user access may be set up for each service.

Referring still to FIG. 2, monitoring tool function 160 may include element monitoring tools 162, SLA monitoring tools 164 and business monitoring tool 166. The element monitoring tools 162 include one or more monitors. Each monitor may monitor one or more resources. For example, the health and usage of a server may be monitored by an element monitoring tool 162.

The SLA monitoring tools 164 may compare the delivery of each service to its applicable SLA. For example, a response time of less that 1 second for a transaction to be completed or an up-time of 99.99% may be specified in the SLA. If a service is unable to meet the requirements of its applicable SLA, the provisioning system 102 may reallocate resource elements (e.g., add extra bandwidth or servers) to enable the service to comply with the SLA. Further, the provisioning system may remove one or more resources from a service if the service, without the removed resource(s), can still comply with the associated SLA. The monitoring tool function 160 may be used to determine if the resulting service complies with the SLA.

The business monitoring tool 166 may be used to track resource consumption by the user. This data may be used for accounting purposes, for capacity planning and to predict the need for additional resource elements. By tracking the rate of users being provisioned to the services, business monitoring 166, for example, can provide early indications that more servers, storage, or software may be needed.

The control system 140 generally governs the overall operation of the provisioning system 102. Referring briefly to FIG. 3, the control system 140 may comprise a policy engine 141 and a workflow engine 143. The control system 140 may receive inputs from the monitoring tools 160 and may process the data in the policy engine 141 to determine what actions are required, if any. The policy engine 141 may produce a plan of action which may include a list of actions and the sequences in which they are to occur. The control system may use the workflow engine 143 to communicate the needed commands to the appropriate provisioning system component. The workflow engine 143 generally implements the plans produced by the policy engine 141. The workflow engine 143 generally cuts across all four functions 130, 140, 150, and 160 of the provisioning system 102 and allows communications with external systems 112 including people which may perform steps in the flow. Workflows may be established for each type of provisioning task. Examples include creating a service, adding capacity, changing management, deleting a user, etc. Some canned workflows may be included in the provisioning system 102.

Referring again to FIG. 3, the policy engine 141 may make decisions based on rules that have been established. Rules may be provided at the business, service and element layers 120-124. Element rules 142 may describe how a resource element 104 may be used in a service. For example, a rule for a particular service resource element might be that the server should only be used in a Web tier, average central processing unit (“CPU”) utilization should not exceed 80% in normal operation, that it should be checked for firmware and/or software updates every 10 days, and that it has a host bus adapter (“HBA”) in it and can be used with a storage area network (“SAN”).

Service rules 144 may describe what actions may be performed at the service layer 122. A service rule may define the action that may be taken in the event of an SLA violation. The rule may specify, for example, that server resources should be added to the service. By way of an additional example, the rule may specify that no action is to be taken in the case in which the service is not business critical.

Business rules 146 may describe how to match the business objectives of the organization to the services provisioned by the provisioning system 102. The business rules may apply when more than one service is involved. In general, the business rules 146 may prioritize various aspects of the organization's business. Examples include, without limitation, increasing the capacity of a financial service by, say, 30% for the last four days of the month by reducing the capacity of the thin client service.

Referring still to FIG. 2, inventory management 150 may provide some of the information used by the control system 140 or other component of the system. The inventory management system 150 may keep track of each element in the target systems and the association of those elements as they are combined into a service. When a service is created or modified, the inventory management system 150 may be updated to reflect the change and the grouping of elements. The resource elements available to be provisioned may be tracked by the inventory management system 150. This function generally comprises multiple repositories, some of which may be included in relational databases and/or directories, and some may be accessed in real-time from the elements in the system.

The four functional areas 130-160 in the provisioning system 102 may work in a coordinated fashion via communication bus 170. In general, these functions communicate with each other to satisfy the provisioning needs of the associated systems. Provisioning system 102 may be configured prior to using it to provisioning services. This configuration process may include creating one or more provisioning tasks that may operate on the resource elements. As described below, such tasks may include creating workflows, developing rules that the workflows may consider, and the development of images and tasks that the workflows may use to provision the resource elements.

The workflows and rules may be programmed via a graphical user interface accessible by an administrator 106 (FIG. 1) on a console. The graphical user interface may also allow defining the physical and logical topology of the desired implementation and which then can be automatically translated into the provisioning tasks required to implement the design. In some embodiments, a flow diagram may be drawn at the administrator console, while other embodiments may be list oriented. The creation of a workflow may include organizing a plurality of commands. The commands may include, without limitation, commands to add servers, change a virtual local area network (“VLAN”), add to load balances set, apply images, obtain service attributes, etc. More than one workflow can be executed simultaneously, and each workflow may be based on the same set of commands.

As explained previously, the control system 140 includes a plurality of rules 142-146. In at least some embodiments, the control system rules may be human-readable and thus readily entered into the control system 140. Rules may be created for each layer 120-124 in the provisioning system 102.

In accordance with some embodiments, manual intervention may occur during the execution of the workflow. It may be desirable for the actions of the provisioning system 102 not to be executed without authorization by a human being (e.g., an administrator). As such, one or more points for manual intervention may be entered during the workflow creation process. Some embodiments may include an “automatic” mode, while other embodiments may include a “manual” mode. In the manual mode, the provisioning system 102 may determine appropriate provisioning tasks and may request confirmation from a human being before executing the task (e.g., before committing a resource for a service). In the automatic mode, the provisioning system executes the task without requiring operator confirmation. Other embodiments may include levels of operation between manual and fully automatic. For example, the provisioning system 102 may be programmed to provision some events automatically, but provision other events only with operator confirmation.

As explained previously, the provisioning system 102 provisions one or more resource elements to form one or more services. Table I below includes a non-exhaustive list of the resources.

TABLE 1
TARGET RESOURCES

| Target Resource | Examples |
|---|---|
| Content | Access control lists, user content such as |
| | Web pages, databases, mail box |
| | content, etc. |
| Access Devices | Thin client device, PDA, desktop |
| Applications | Software components including mail |
| | server, Web server, etc. |
| Security | Firewalls, intrusion detection software, |
| | etc. |
| Middleware | Application servers, message queuing |
| | systems, etc. |
| Management Entities | Agents that collect data and operate |
| | remotely |
| Operating System | Microsoft Windows, Linux, HP-UX, etc. |
| Server | IA32 Server, IA64 server, |
| Storage | Direct attached devices, network |
| | attached devices, storage area network |
| | devices, etc. |
| Network | Routers, switches, etc. |
| Environmental | Power, temperature, physical location |

In some embodiments, the target resources may be in one of a plurality of states including, without limitation, production, development and quality assurance (“QA”), and spare. A resource can be provisioned to implement a service if it is in the production state. In the development and QA state, the resource may not be ready to be used in a service as it may be in a state in which it is being fixed or updated to a new configuration.

The spare resource state may comprise one or more pools. One pool comprises the general resource pool which includes resource elements that are available to be provisioned. Thus, when additional capacity is needed for a service, resource elements may be taken from this pool. Further, resource elements may be returned to this pool when they are no longer needed to support a particular service level.

A capacity-on-demand (“COD”) pool may be included. This pool may be used to prevent the general resource pool from being completed depleted. Some suppliers may have equipment that is available for use while still being owned by the supplier. Such resources are identified in the COD pool. The provisioning system 102 may redesignate such a resource from the COD pool to the general resource pool when, for example, the quantity of resources in the general resource pool falls below a predetermined threshold. This capability helps to ensure that a sufficient level of resources may be available to the provisioning system to meet the various SLAs that may be in place.

A maintenance pool designation may be used for any resource that is determined to be faulty. The monitoring function 160 of the provisioning system 102 may determine when a resource is experiencing faulty operation. A faulty resource then may be placed into the maintenance pool. Once repaired, the resource may be returned to the general resource pool.

As shown in FIG. 1, one or more suppliers 110 may interact with provisioning system 102. The suppliers 110 may provide resources 104 and act as a triggering function to initiate provisioning actions. An example of a triggering function may include a supplier 110 indicating to the provisioning system the existence of updates to that supplier's resources (e.g., software updates). In response, the provisioning system 102 may initiate a provisioning action to implement the update.

The following includes examples of the operation of the provisioning system 102 in reference to FIGS. 1-3. In the first example, a supplier 110 may have a software patch available for the provisioning system to implement. The following actions may be performed by the provisioning system 102. An element monitoring tool 162 may detect that the patch is available. This action may occur via email or other form of electronic messaging or signaling between supplier 110 and provisioning system 102. The monitoring system 160 informs the control system 140 of the patch and, if desired, the control system may notify an administrator 106. An administrator 106 then may perform an action to determine whether the patch is virus-free or compare the update against predetermined criteria. Data center personnel may create a virus patch script, a verify script and may modify the workflow for this particular patch by execution of the workflow engine 243 (FIG. 3).

The patch may apply to all servers or only a subset of all servers. Interaction between the control system 140 and the inventory management system 150 permits a determination to be made as to which server resources may require the patch. For example, the supplier 110 may indicate that the patch applies to only a particular type or class of server. The inventory management system 150 examines the system's collection of servers to determine if that particular type or class of server is present in the system.

Continuing with this example, an element rule 142 ensures that the application to which the patch applies is placed into a quiescent state so that the patch can be applied. For example, a server may be redesignated from the production state for a Web farm by using the provisioning tool 130 to communicate with a load balancer which controls access to the affected server. The control system 140 may communicate with the provisioning tools 130 to run one or more scripts to install the patch. The control system 140 then may reboot the system if necessary and run various verification scripts to verify the patch was correctly installed. The control system 140 also may cause the provisioning tools 130 to transition the updated server back into production and back into the Web farm via the load balancer. The inventory management system 150 may be updated to reflect that the updated server is back on-line with the software patch.

By way of an additional example, the provisioning system 102 may react as described below to a server failure. The monitoring system 160 may detect that a server has stopped working correctly and may inform the control system 140 of this condition. The control system may determine the cause of the failure and determine that the failure is hardware related. The control system then may notify a load balancer so that the failed server can be taken off line to permit repair or replacement. An administrator 106 may be notified of the failed server so that the administrator can cause the server to be replaced or repaired.

Before the failed server is replaced, the configuration of the failed server is determined so that the replacement server can be configured in the same or similar fashion. Determining the configuration of the failed server may be accomplished using the control and inventory systems 140, 150. Then, a replacement server may be installed and configured. The newly replaced server may be tested by running one or more QA scripts and then placed back into production by the provisioning tools 130.

The next example involves a data center bringing a new service on-line. For example, a company may desire to create a new website. After the customer designs the new website, the control system 140 may determine from the inventory management system 150 whether appropriate resources are available in the various pools discussed above or whether additional resources need to be ordered. If the needed server is not already installed, the control system may initiate a work order to cause the server to be installed. The control system 140 may also cause the provisioning tools 130 to reuse an existing configuration for the new server or use a newly created configuration. The control system 140 may also cause one or more QA scripts to be run to check the server for correct operation before it is used in a service. The provisioning tools 130 then may cause the server to be placed into use.

In other embodiments, the architecture may be used to identify any of a variety of characteristics such as identifying overlaps and gaps in capabilities. FIG. 5 shows an exemplary embodiment of a worksheet 300 which may be representative of the architecture depicted in FIG. 2. The worksheet 300 may be formed on paper or in a computer file and shown on an administrator's console. The worksheet may include sections 302, 304 and 310. Section 302 may permit information to be entered about the system being analyzed. Section 304 may permit component identifiers to be overlayed over the various functions 130-160 and layers 120, 122 and 124. Similarly, section 310 may permit components identifiers to be overlayed over the various resources in a target stack 312 of resources while also indicating the function 130-160 to which the component is applicable.

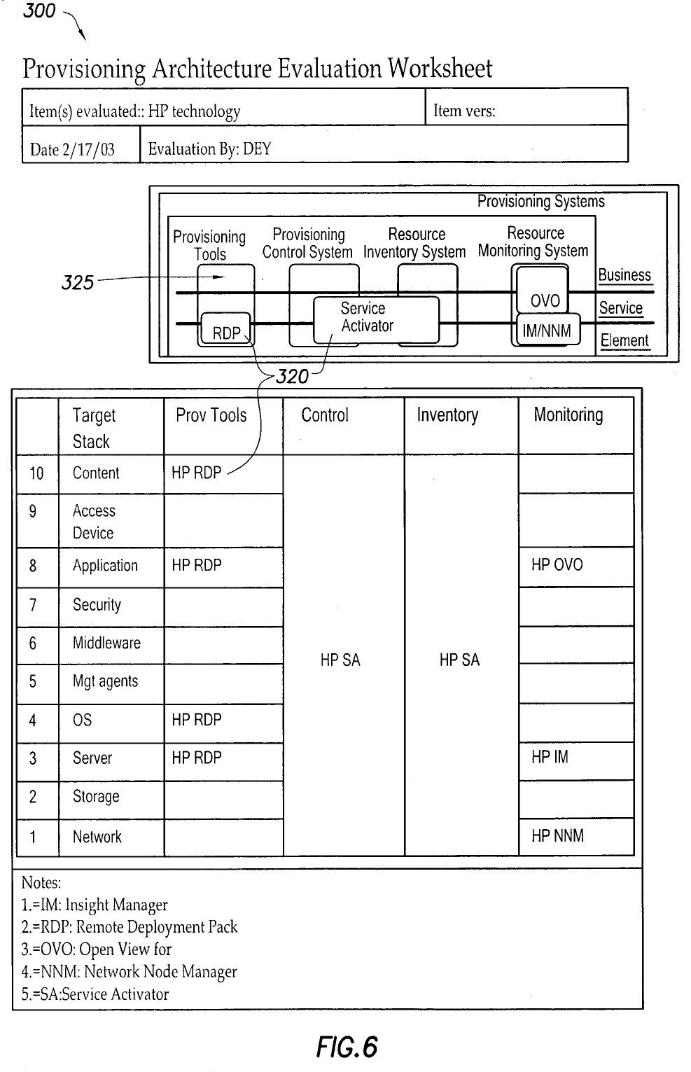

FIG. 6 shows a worksheet 300 filled out in accordance with an exemplary implementation. Identifiers 320 are shown. From worksheet 300 any gaps or overlaps can easily be identified. For example, at reference numeral 325 in FIG. 6 it can be seen that no component is available in the business layer 120 associated with the provisioning tools.

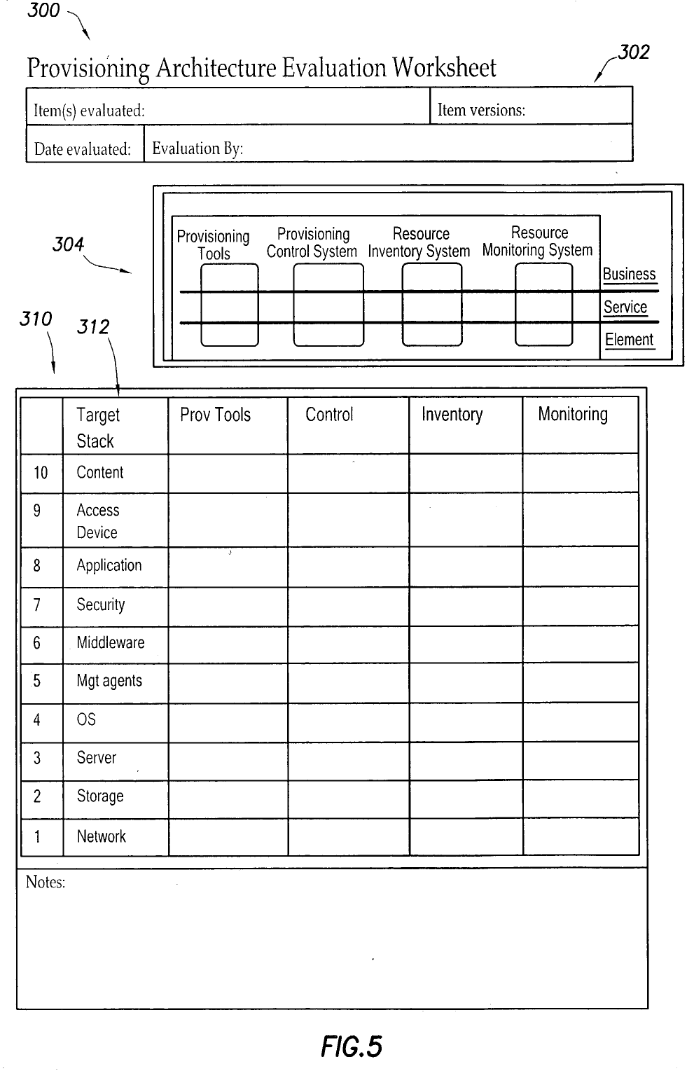

The provisioning system 102 may comprise software executed on a suitable computer. FIG. 4 shows an exemplary block diagram of a computer system 200 in which provisioning system 102 may be installed. The exemplary computer system 200 may include one or more central processing units (“CPUs”) 202, volatile memory 204, and non-volatile memory 206 coupled to host bridge logic 208. The non-volatile memory 206 may comprise a hard drive, CD ROM drive or other suitable form of permanent storage in which provisioning system 102 may be stored pending execution by CPU 202. The provisioning system 102 may be copied to volatile memory 204 and executed therefrom by CPU 202. In other embodiments, the provisioning system 102 may be distributed across multiple computer systems.

In general, the provisioning system 102 enables a closed loop system which self-adapts to its environment, adding resources when needed and decommissioning resources that are no longer needed. The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method, comprising:
receiving information pertaining to a specified service;
automatically determining whether resources are available to implement a specified service; and
provisioning resources to implement the specified service.

2. The method of claim 1 wherein said provisioning resources includes automatically provisioning said resources without human involvement.

3. The method of claim 1 wherein said provisioning resources includes manually provisioning said resources, wherein manually provisioning includes permitting a person to verify the resource before provisioning said resource.

4. The method of claim 1 wherein said provisioning resources includes automatically provisioning some of said resources and manually provisioning other of said resources, wherein manually provisioning includes permitting a person to verify resource provisioning.

5. The method of claim 1, further including monitoring said provisioned resources for errors and performing a response action if a resource is determined to have errors.

6. The method of claim 5 wherein said response action includes replacing said erroneous resource with a replacement resource.

7. The method of claim 1 wherein said resources include resources selected from the group consisting of servers, storage devices, network devices, bandwidth, load balancers, security features, software licenses, operating systems, application software, user content and environmental resources.

8. The method of claim 1 further including notifying a supplier that resources are needed from a local capacity-on-demand pool.

9. The method of claim 1 further including comparing available management components to a graphic depiction of the architecture in which said resources are provisioned and determining if additional resources are needed to complete the architecture showing interface points and capabilities.

10. A method usable in conjunction with a service comprising a plurality of resource elements, said method comprising:
monitoring said resources to determine if a resource malfunctions or no longer meets a predetermined service level;
automatically replacing a resource that has malfunctioned with a new resource to perform a function performed by said replaced resource; and
automatically configuring said new resource to perform said function.

11. The method of claim 10 wherein said replaced resource and said new resource comprise a component selected from the group consisting of servers, network devices, storage devices, software, and data content.

12. The method of claim 10 wherein said monitoring includes determining whether said resources permit said service to comply with a service level agreement.

13. The method of claim 12 further including adding an additional resource if said service is not complying with said service level agreement.

14. The method of claim 10 further including determining whether a resource can be removed from the service and still permit said service to perform its intended functions.

15. The method of claim 14 further including removing a resource from a service if it is determined that the resource can be removed and still permit the service to perform its functions.

16. The method of claim 10 further including receiving a notification from a supplier of resources that indicates that an update is available and automatically downloading said update.

17. The method of claim 16 further including automatically scanning said update for viruses or comparing said. update against predetermined criteria.

18. The method of claim 16 further including automatically installing said update into said service without having to stop the service.

19. The method of claim 16 further including permitting a person to verify whether said patch is to be installed into said service.

20. A provisioning system usable in conjunction with a plurality of resources that perform one or more services, comprising:
provisioning tools;
a monitoring system that monitors said resources to determine if a resource malfunctions or against a metric;
said provisioning tools and monitoring system coupled together via a communication bus;
said provisioning tools automatically replace a resource that has malfunctioned as indicated by the monitoring system with a new resource to perform a function performed by said replaced resource; and
said provisioning tools also automatically configure said new resource to perform said function.

21. The system of claim 20 further including a control system also coupled to said communication bus and controls the operation of the provisioning tools and monitory system.

22. The system of claim 21 further including an inventory management system that is accessed by said control system to determine whether a new resource is available for replacement of said malfunctioned resource.

23. The system of claim 20 wherein said control system comprises a plurality of element rules that specifies how a resource can be used in said system.

24. The system of claim 23 wherein said control system comprises a plurality of service rules that each specify an action to be performed in the event a service fails to comply with an associated service level agreement.

25. The system of claim 24 wherein said control system comprises a plurality of business rules that each prioritize a plurality of business objectives.

26. The system of claim 24 further including a mapping between objectives and the resources such that an impact on the objectives is determinable if a resource changes and an impact on the resources is determinable if an objective changes.

27. A provisioning system usable in conjunction with a plurality of resources that perform one or more services, comprising:
a means for monitoring said resources to determine if a resource malfunctions; and
a means for automatically replacing a resource that has malfunctioned with a new resource to perform a function performed by said replaced resource and for automatically configuring said new resource to perform said function.

28. The system of claim 27 further including a means for determining whether a new resource is available for replacement of said malfunctioned resource.

29. A provisioning system usable in conjunction with a plurality of resources, comprising:
provisioning tools;
a monitoring system that monitors said resources to determine if a resource malfunctions;
an inventory management system;
said provisioning tools, monitoring system and inventory management system coupled together via a communication bus;
said inventory management system determines whether sufficient resources are available to implement a user-requested service;
said provisioning tools automatically select a resource to perform said requested service.

30. The system of claim 29 wherein said provisioning tools automatically select a plurality of resources to perform said requested service.

31. The system of claim 30 wherein said monitoring system determines whether a service is complying with an associated service level agreement.

32. The system of claim 31 wherein said provisioning tools adds a resource to a service that is not complying with a service level agreement.

33. The system of claim 31 wherein said provisioning tools removes a resources from a service that is complying with a service level agreement and can continue to comply with said service level agreement even when said resource is removed.

34. A storage medium on which code is stored, said code being executable by a processor and comprising instructions, said instructions including:
receiving information pertaining to a service;
automatically determining whether resources are available to implement a specified service; and
provisioning resources to implement the specified service.

35. The storage medium of claim 34 wherein said provisioning occurs automatically without human involvement.
